(19) United States
(12) Patent Application Publication
(10) Pub. No.: US 2002/0118532 A1
(43) Pub. Date: Aug. 29, 2002

(54) Illuminated helmet with swiveling head lamp

(76) Inventor: F. Martin Gates, Skokie, IL (US)

Correspondence Address: F. Martin Gates, 8305 N. Trumbull, Skokie, IL, 60076, US

(21) Appl. No.: 09/796,014

(22) Filed: Feb. 28, 2001

(51) Int. Cl. F21V 21/084

(52) U.S. Cl. 362/105

(57) ABSTRACT

An illuminated helmet with swiveling head lamp (10) having a helmet (12 ) which has a helmet outer shell (12O) securely attached to a helmet inner shell (12I). The helmet (12) further has helmet foam (12B) sandwiched between the helmet outer shell (12O) and the helmet inner shell (12I). A helmet cavity (12C) is positioned within a front of the helmet (12). The illuminated helmet with swiveling head lamp (10) a strap (14) is securely attached to the helmet (12). The strap (14) has a left strap (14L) securely attached at a top distal end to a left side of the helmet (12) by a fastener (18) and a right strap (14R) securely attached at a top distal end to a right side of the helmet (12) by a fastener (18). A left strap fastener (14LA) is securely attached at a bottom distal end of the left strap (14L) and a right strap fastener (14RA) is securely attached at a bottom distal end of the right strap (14R). The left strap fastener (14LA) and the right strap fastener (14RA) has complimentary configurations securely attachable to each other. The illuminated helmet with swiveling head lamp (10) a light (16) securely mounted on a front end within the helmet (12). The light (16) has a watertight light lamp (16A) electrically connected to a light switch (16B) electrically connected to at least one light battery which is positioned within a light battery compartment.

### BACKGROUND OF THE INVENTION

1. Field of the Invention

The present invention relates to an illuminated helmet. More particularly, the present invention relates to an illuminated helmet with swiveling head lamp

2. Description of the Prior Art

The most commonly known prior art is a light with a strap which bicyclists attach to their helmet. Although it functions, the device has limitations as hereafter described.

Numerous innovations for illuminated helmets have been provided in the prior art that are described as follows. Even though these innovations may be suitable for the specific individual purposes to which they address, they differ from the present invention as hereinafter contrasted.

In U.S. Pat. No. 5,559,680, titled Electroluminescent Bicycle Helmet, invented by Dennis A. Tabanera, a bicycle helmet is described having (a) a structural foam liner, (b) a plastic shell overlay the liner and having a transparent zone and an opaque zone, (c) an electroluminescent lamp film located between the liner and the shell and positioned to emit light from the transparent window, (d) a battery and (e) an inverter. The battery and inverter are housed in pockets on opposite sides (left, right) of the helmet for providing a weight balanced helmet. The battery is an electrical communication with the inverter for supplying direct current thereto. The inverter converts the direct current to alternating current and is in electrical communication with the film for causing light to be emitted therefrom. The cover units for the pockets are preferably shaped for desirable aerodynamic, structural and atheistic properties.

The patented invention differs from the present invention because the patented invention is a bicycle helmet is provided having a structural foam liner. The patented invention further includes a light built in to the helmet. A plurality of compartments house a battery and inverter which are positioned in compartments on opposite sides of the helmet functioning to balance the weight distribution. The inverter converts the direct current to alternating current and is in electrical communication with the film for causing light to be emitted therefrom. The cover units for the pockets are preferably shaped for desirable aerodynamic, structural and atheistic properties. The illumination is designed as a running light to indicate the presence of a bicycler. The patented invention is limited in that it does not provide for illumination of the road as does the present invention. Further, the patented invention lacks a light direction control.

In U.S. Pat. No. 5,469,342, titled Light-strip Apparatus, invented by Tseng L. Chien, a light-strip apparatus including a flexible lower strip, a transparent flexible upper strip detachably engaged to the lower strip thus together forming a sheath, an elongated flexible light-emitting device being received in the sheath for emitting light, and a power box attached to a substantially central portion of the flexible light-emitting device for providing AC power to enable the flexible light-emitting device to flash. The flexible light-emitting device has a plurality of spots sequentially connected by interconnected lines and the spots and the lines will flash if the light-emitting device is electrified by the power box.

The patented invention differs from the present invention because the patented invention is a light-strip apparatus which is mounted external; to a hat. The patented invention lacks a compartment with in the head gear device. The illumination of the patented invention is designed as a running light to indicate the presence of a bicycler. The patented invention is limited in that it does not provide for illumination of the road as does the present invention. Further, the patented invention lacks a light direction control.

In U.S. Pat. No. 5,327,587, titled Illuminated Safety Helmet, invented by Marni Hurwitz, an illuminated safety helmet is described including at least one electroluminescent strip permanently adhered to a helmet shell which is powered by a power unit arranged on the helmet shell, where the power unit includes a rechargeable battery. Power is supplied to the electroluminescent strips when an ON/OFF switch is turned ON.

The patented invention differs from the present invention because the patented invention is an illuminated safety helmet is described including at least one electroluminescent strip permanently adhered to a helmet shell which is powered by a power unit arranged on the helmet shell, where the power unit includes a rechargeable battery. The illumination of the patented invention is designed as a running light to indicate the presence of a bicycler. The patented invention is limited in that it does not provide for illumination of the road as does the present invention. Further, the patented invention lacks a light direction control.

In U.S. Pat. No. 5,111,366, titled Cap Having Illuminated Indicia, invented by Guerin D. Rife and W. Preston Willingham, a cap for displaying information on the front thereof, this cap comprising a crown portion adapted to be worn on the head of the user and having a front section, with the front section having an opening therein. Adjacent this opening is a panel-supporting arrangement, with this panel-supporting arrangement being configured to receive a panel of transparent material and to support same adjacent the opening. The transparent panel is illuminated from its edge, with a battery supplying the power for the illumination arrangement.

The patented invention differs from the present invention because the patented invention is a cap for displaying information on the front thereof. The transparent panel is illuminated from its edge, with a battery supplying the power for the illumination arrangement. The patented invention lacks a compartment with in the head gear device. The illumination of the patented invention is designed as a running light to indicate the presence of a bicycler. The patented invention is limited in that it does not provide for illumination of the road as does the present invention. Further, the patented invention lacks a light direction control.

In U.S. Pat. No. 4,319,308, titled Helmet for Providing a Sensory Effect to an Observer, invented by Augusto Ippoliti, Ripoli Bagno, and Silvana Lisotti , a helmet is described for motorcyclists for providing a sensory effect to observers. The helmet is provided with an inner portion and an outer portion which are spaced from each other to provide for an interspace between the two portions. Positioned within the two portions is a light emitting device, a tape player, and power source in the form of a battery. One or more switches may be provided on the outer portion which interconnects the light source with the battery or the tape player with the battery or both to provide the light and/or sound effect in the interspace. The outer portion may be formed from material which is partially or wholly transparent, or translucent with some opaque portions. Character emitting openings may be provided on the outer portion and the outer portion may have different colors or the light may be of different colors to provide different light sensory effects to the observer. The inner and outer portions may also be provided with openings for the sound to go out of the interspace between the inner and outer portions.

The patented invention differs from the present invention because the patented invention is a helmet having an inner portion and an outer portion which are spaced from each other to provide a compartment. Positioned within the two portions is a light emitting device, a tape player, and power source in the form of a battery. One or more switches may be provided on the outer portion which interconnects the light source with the battery or the tape player with the battery or both to provide the light and/or sound effect in the interspace. The outer portion may be formed from material which is partially or wholly transparent, or translucent with some opaque portions. Character emitting openings may be provided on the outer portion and the outer portion may have different colors or the light may be of different colors to provide different light sensory effects to the observer. The inner and outer portions may also be provided with openings for the sound to go out of the interspace between the inner and outer portions. The illumination of the patented invention is designed as a running light to indicate the presence of a bicycler. The patented invention is limited in that it does not provide for illumination of the road as does the present invention. Further, the patented invention lacks a light direction control.

In U.S. Pat. No. 4,231,079, titled Article of Wearing Apparel, invented by Stephen R. Heminover, an article of wearing apparel such as a rigid opaque hat or a multi-layer belt has light emitting diodes mounted therein for being viewed, the terminals of the diodes and the circuitry for controlling the same being concealed within the article of apparel or on the person of the wearer. Control circuitry includes an electronic clock which sends electric pulses to an electronic counter, the output of which passes through a decoder which controls which diodes are sequentially illuminated to create an illusion of motion for getting the attention of others or for providing a type of theatrical ornamentation for the user.

The patented invention differs from the present invention because the patented invention is an article of wearing apparel such as a rigid opaque hat or a multi-layer belt has light emitting diodes mounted therein for being viewed. Control circuitry includes an electronic clock which sends electric pulses to an electronic counter, the output of which passes through a decoder which controls which diodes are sequentially illuminated to create an illusion of motion for getting the attention of others or for providing a type of theatrical ornamentation for the user. The patented invention is limited in that it does not provide for illumination of the road as does the present invention. Further, the patented invention lacks a light direction control.

Numerous innovations for an Illuminated Helmet with Swiveling Head lamp have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention is designed to provide the bicyclist with a head lamp that is integrated into the structure of the helmet itself. Preferably, the head lamp is swivelable to allow the rider to see things at any given angle. For example, if a rider prefers to watch a left side of a path while riding off road and a right side of a road while riding, the swiveling action would permit him/her to adjust the lamp in such a way that it is already aligned in the direction of interest, thus, allowing a better view of potential road hazards.

The types of problems encountered in the prior art are strap on lights are cumbersome and non-adjusting.

In the prior art, unsuccessful attempts to solve this problem were attempted namely: moving the strap from one side of the helmet to the other. However, the problem was solved by the present invention because the light lamp swivels.

Innovations within the prior art are rapidly being exploited in the field of bicycle safety.

The present invention went contrary to the teaching of the art which describes and teaches attachable lights.

The present invention solved a long felt need for an integrated swiveling light.

The present invention produced unexpected results namely; reduced bicycle accidents.

A synergistic effect was produced utilizing the present invention due to the following facts and results from experimentation: that bicycle tire damage was reduced as a result of increased visibility.

Accordingly, it is an object of the present invention to provide an illuminated helmet with swiveling head lamp having a helmet, strap, and light.

More particularly, it is an object of the present invention to provide helmet front vent, helmet rear vent, helmet foam, helmet cavity, helmet padding, helmet visor, helmet outer shell, and helmet inner shell.

In keeping with these objects, and with others which will become apparent hereinafter, one feature of the present invention resides, briefly stated, in the strap comprising a left strap and a right strap.

When the left strap is designed in accordance with the present invention, it comprises a left strap fastener and a left strap retainer.

In accordance with another feature of the present invention, the right strap comprises a right strap fastener and a right strap retainer.

Another feature of the present invention is that the light comprises a light lamp, light switch, light rear battery compartment, light rear battery compartment, light rear battery, and light front battery.

Yet another feature of the present invention is that the light rear battery compartment comprises a watertight light rear battery compartment cover and a light rear battery compartment latch. Still another feature of the present invention is that the light rear battery compartment comprises a watertight light rear battery compartment cover and a light rear battery compartment latch.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### LIST OF REFERENCE NUMERALS UTILIZED IN THE DRAWINGS

10—illuminated helmet With swiveling head lamp (10)

12—helmet (12)

12AF—helmet front vent (12AF)

12AR—helmet rear vent (12AR)

12B—helmet foam (12B)

12C—helmet cavity (12C)

12D—helmet padding (12D)

12E—helmet visor (12E)

120—helmet outer shell (120)

12I—helmet inner shell (12I)

14—strap (14)

14L—left strap (14L)

14LA—left strap fastener (14LA)

14LB—left strap retainer (14LB)

14R—right strap (14R)

14RA—right strap fastener (14RA)

14RB—right strap retainer (14RB)

16—light (16)

16A—light lamp (16A)

16B—light switch (16B)

16DR—light rear battery compartment (16DR)

16DRA—light rear battery compartment cover (16DRA)

16DRB—light rear battery compartment latch (16DRB)

16DF—light rear battery compartment (16DF)

16DFA—light rear battery compartment cover (16DFA)

16DFB—light rear battery compartment latch (16DFB)

16R—light rear battery (16R)

16F—light front battery (16F)

18—fastener (18)

### BRIEF DESCRIPTION OF THE DRAWINGS

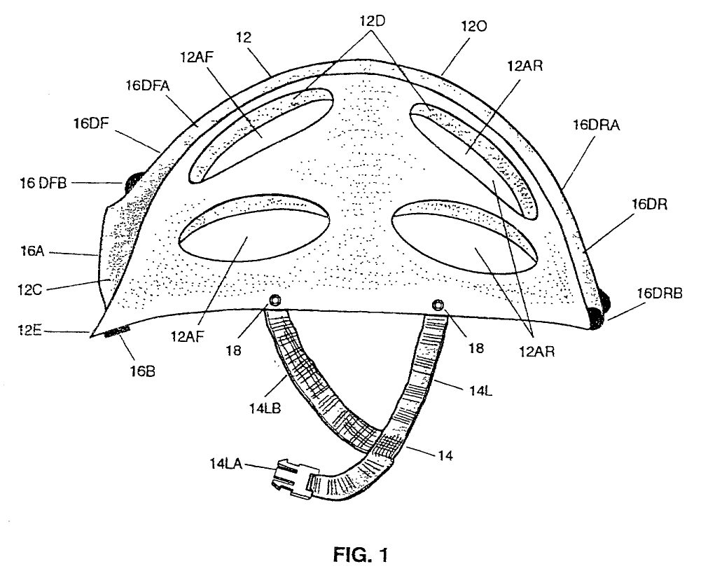

FIG. 1 is a side view of an illuminated helmet With swiveling head lamp (10).

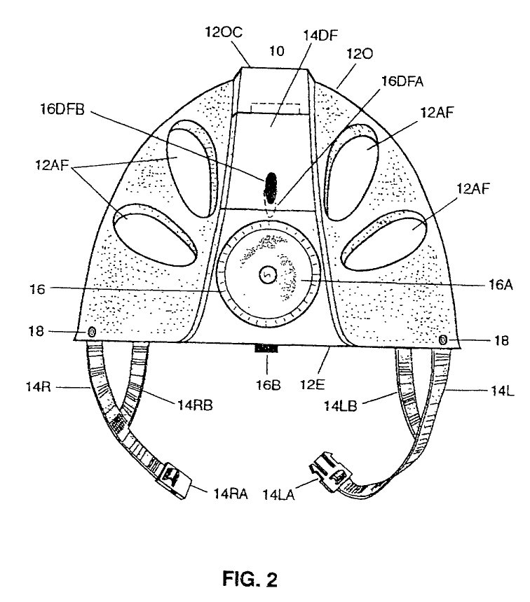

FIG. 2 is a front view of an illuminated helmet With swiveling head lamp (10).

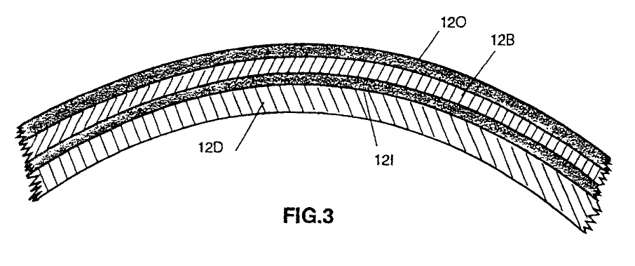

FIG. 3 is a cross sectional view of a helmet (12).

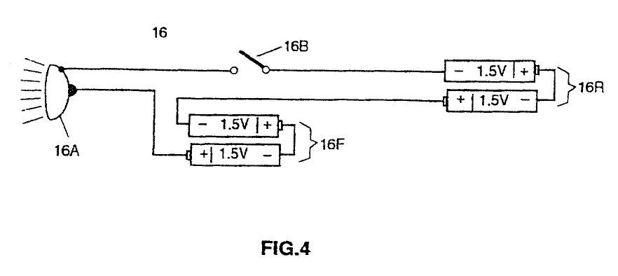

FIG. 4 is a schematic view of a light (16).

### DESCRIPTION OF THE PREFERRED EMBODIMENT

Firstly, referring to FIG. 1 and FIG. 2 which are side and front views, respectively, of an illuminated helmet with swiveling head lamp (10). The illuminated helmet with swiveling head lamp (10) comprises a helmet (12) which comprises a helmet outer shell (12O) securely attached to a helmet inner shell (12I). Referring to FIG. 3 which is a cross sectional view of a helmet (12). The helmet (12) further comprises helmet foam (12B) sandwiched between the helmet outer shell (120) and the helmet inner shell (12I). A helmet cavity (12C) is positioned within a front of the helmet (12). The helmet (12) further comprises at least one helmet front vent (12AF). The helmet (12) further comprises at least one helmet rear vent (12AR). The helmet (12) further comprises helmet padding (12D) securely attached to an inner surface of the helmet inner shell (12I). The helmet (12) further comprises a helmet visor (12E).

A strap (14) is securely attached to the helmet (12). The strap (14) comprises a left strap (14L) securely attached at a top distal end to a left side of the helmet (12) by a fastener (18) and a right strap (14R) securely attached at a top distal end to a right side of the helmet (12) by a fastener (18). A left strap fastener (14LA) is securely attached at a bottom distal end of the left strap (14L) and a right strap fastener (14RA) is securely attached at a bottom distal end of the right strap (14R). The left strap fastener (14LA) and the right strap fastener (14RA) comprises complimentary configurations securely attachable to each other. The left strap (14L) further comprises a left strap retainer (14LB) securely attached at a top distal end to the left side of the helmet (12) by a fastener (18) and securely attached at a bottom distal end an approximate midpoint of the left strap (14L) forming an opening therebetween for a user's left ear. The right strap (14R) further comprises a right strap retainer (14RB) securely attached at a top distal end to the right side of the helmet (12) by a fastener (18) and securely attached at a bottom distal end an approximate midpoint of the right strap (14R) forming an opening therebetween for a user's right ear.

Now referring to FIG. 4 which is a schematic view of a light (16) which is securely mounted on a front end within the helmet (12). The light (16) comprises a watertight light lamp (16A) electrically connected to a light switch (16B) electrically connected to at least one light battery which is positioned within a light battery compartment. The light (16) further comprises a light rear battery compartment (16DR) positioned in a rear of the helmet (12). The light rear battery compartment (16DR) comprises a watertight light rear battery compartment cover (16DRA) having a light rear battery compartment latch (16DRB). The at least one battery comprises a light rear battery (16R) positioned within the light rear battery compartment (16DR). The light (16) further comprises a light left battery compartment (16DL) positioned in a rear of the helmet (12). The light left battery compartment (16DL) comprises a watertight light front battery compartment cover (16DFA) having a light front battery compartment latch (I6DFB). The at least one battery comprises a light front battery (16F) positioned within the light front battery compartment (16DF). The light lamp (16A) is preferably movably positioned within the helmet cavity (12C). The light lamp (16A) and the at least one battery are 6 volts functioning to produce light with minimal heat. The light switch (16B) is positioned under the helmet visor (12E) functioning for easy access and away from adverse weather conditions.

It will be understood that each of the elements described above, or two or more together, may also find a useful application in other types of constructions differing from the type described above.

While the invention has been illustrated and described as embodied in an illuminated helmet, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. An illuminated helmet with swiveling head lamp (10) comprising:
A) a helmet (12) which comprises a helmet outer shell (12O) securely attached to a helmet inner shell (12I), the helmet (12) further comprises helmet foam (12B) sandwiched between the helmet outer shell (12O) and the helmet inner shell (12I), a helmet cavity (12C) is positioned within a front of the helmet (12);
B) a strap (14) is securely attached to the helmet (12), the strap (14) comprises a left strap (14L) securely attached at a top distal end to a left side of the helmet (12) by a fastener (18) and a right strap (14R) securely attached at a top distal end to a right side of the helmet (12) by a fastener (18), a left strap fastener (14LA) is securely attached at a bottom distal end of the left strap (14L) and a right strap fastener (14RA) is securely attached at a bottom distal end of the right strap (14R), the left strap fastener (14LA) and the right strap fastener (14RA) comprises complimentary configurations securely attachable to each other; and
C) a light (16) securely mounted on a front end within the helmet (12), the light (16) comprises a watertight light lamp (16A) electrically connected to a light switch (16B) electrically connected to at least one light battery which is positioned within a light battery compartment.

2. The illuminated helmet with swiveling head lamp (10) as described in claim 1, wherein the helmet (12) further comprises at least one helmet front vent (12AF).

3. The illuminated helmet with swiveling head lamp (10) as described in claim 1, wherein the helmet (12) further comprises at least one helmet rear vent (12AR).

4. The illuminated helmet with swiveling head lamp (10) as described in claim 1 further comprises helmet padding (12D) securely attached to an inner surface of the helmet inner shell (12I).

5. The illuminated helmet with swiveling head lamp (10) as described in claim 1 further comprises helmet visor (12E).

6. The illuminated helmet with swiveling head lamp (10) as described in claim 1, wherein the left strap (14L) further comprises a left strap retainer (14LB) securely attached at a top distal end to the left side of the helmet (12) by a fastener (18) and securely attached at a bottom distal end an approximate midpoint of the left strap (14L) forming an opening therebetween for a user's left ear.

7. The illuminated helmet with swiveling head lamp (10) as described in claim 1, wherein the right strap (14R) further comprises a right strap retainer (14RB) securely attached at a top distal end to the right side of the helmet (12) by a fastener (18) and securely attached at a bottom distal end an approximate midpoint of the right strap (14R) forming an opening therebetween for a user's right ear.

8. The illuminated helmet with swiveling head lamp (10) as described in claim 1, wherein the light (16) further comprises a light rear battery compartment (16DR) positioned in a rear of the helmet (12), the light rear battery compartment (16DR) comprises a watertight light rear battery compartment cover (16DRA) having a light rear battery compartment latch (16DR), the at least one battery comprises a light rear battery (16R) positioned within the light rear battery compartment (16DR).

9. The illuminated helmet with swiveling head lamp (10) as described in claim 1, wherein the light (16) further comprises a light left battery compartment (16DL) positioned in a rear of the helmet (12), the light left battery compartment (16DL) comprises a watertight light front battery compartment cover (16DFA) having a light front battery compartment latch (16DFB), the at least one battery comprises a light front battery (16F) positioned within the light front battery compartment (16DF).

10. The illuminated helmet with swiveling head lamp (10) as described in claim 1, wherein the light lamp (16A) is movably positioned within the helmet cavity (12C).

11. The illuminated helmet with swiveling head lamp (10) as described in claim 1, wherein the light lamp (16A) and the at least one battery are 6 volts functioning to produce light with minimal heat.

12. The illuminated helmet with swiveling head lamp (10) as described in claim 1, wherein the light switch (16B) is positioned under the helmet visor (12E) functioning for easy access and away from adverse weather conditions.
